(19) United States
(12) Patent Application Publication
(10) Pub. No.: US 2010/0172392 A1
(43) Pub. Date: Jul. 8, 2010

(54) MEASUREMENT ARRANGEMENT FOR MEASURING A TEMPERATURE OF A RECHARGEABLE POWER SUPPLY DEVICE

(76) Inventors: Steffen Katzenberger, Bad Liebenzell (DE); Wolf Matthias, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/663,660

(22) PCT Filed: May 5, 2008
(86) PCT No.: PCT/EP2008/055464

§ 371 Date: Dec. 8, 2009

(30) Foreign Application Priority Data
Jun. 27, 2007 (DE) 10 2007 029 745.0
Nov. 16, 2007 (DE) 10 2007 054 811.9

(51) Int. Cl. G01K 7/22; G01K 13/00

(52) U.S. Cl. 374/166; 374/185; 374/E13.001; 374/E07.028

(57) ABSTRACT

A measurement arrangement for measuring a temperature of a rechargeable power supply device, such as a battery pack, for an electrical appliance. The power supply device has at least one measurement object, such as a battery. At least one thermosensor element, such as a PTC or NTC resistor, is provided on a ribbon cable and is positioned between the measurement object and an outer sheath.

### PRIOR ART

The invention relates to a measurement arrangement for measuring a temperature of a rechargeable power supply device, such as a rechargeable battery pack or battery pack.

From the prior art, rechargeable battery packs for power tools are generally known, in which thermosensors are used in order to monitor the temperature of the rechargeable battery pack. Preferably, so-called temperature-dependent resistors, such as NTCs (negative temperature coefficient) or PTCs (positive temperature coefficient) are used as the thermosensors. Particularly for charging with high currents both in fast charging and also in lithium-ion rechargeable battery packs, for the sake of safety while current is being drawn, the temperature of the rechargeable battery cells is detected with as little delay as possible and as precisely as possible. An NTC resistor, for instance, can be secured by means of a thermally conductive adhesive tape to an individual cell that was previously freed of its paper insulation. The cells of the rechargeable battery pack may also be cooled via a heat sink.

From German Patent Disclosure DE 102 14 366 A1, a rechargeable battery pack is known in which a temperature sensor is connected to a heat sink of the rechargeable battery pack. The temperature sensor can touch the heat sink directly and even be encapsulated in it, or a heat conductor element can for instance be disposed between the temperature sensor and the heat sink.

From German Patent Disclosure DE 102 14 368 A1, a measurement arrangement is also known for measuring the temperature of a rechargeable battery cell. A temperature sensor in the form of an NTC resistor is provided, which has two conductor legs that are inserted through suitable solder eyelets in a circuit board and soldered to the board. The thermal connection of the temperature sensor to a rechargeable battery cell is effected via a heat-conducting element, for instance comprising a thermally conductive rubber.

In the present invention, as claimed in claim 1, a measurement arrangement for measuring a temperature of a power supply device for an electrical appliance is now furnished. The power supply device has at least one object to be measured, on which the thermosensor element is provided. To that end, in contrast to the prior art, the thermosensor element is secured to a ribbon cable, and the entirety is disposed in a gap between the object being measured and an outer sheath. This has the advantage that because of the securing of the thermosensor element to the ribbon cable and the insertion of the entirety between the object being measured and its sheath, very simple and economical assembly can be attained. Moreover, a good heat transfer can be assured, since a direct mechanical contact can be made between the thermoelement and the object being measured.

In a preferred embodiment of the invention, the thermosensor element is for instance an NTC resistor or a PTC resistor. The NTC resistor, for instance, has the advantage that a fast reaction time can be assured, since as a thermosensor element, the resistor intrinsically has a fast reaction time.

In a further preferred embodiment, the NTC resistor or PTC resistor is provided without a housing on the ribbon cable. This has the advantage that a very much shallower mode of construction can be attained than with the conventionally-wired NTC resistors of the kind explained hereinafter in conjunction with FIG. 1.

In a further embodiment of the invention, the rechargeable power supply device is a rechargeable battery pack or a battery pack. The object being measured then is a rechargeable battery cell or battery element. The thermosensor element is thrust between the respective rechargeable battery cell or battery element and its sheath, which permits very simply securing of the thermosensor element. In principle, not only a single thermosensor element but also at least two or more thermosensor elements can be disposed on the respective object being measured, for instance to compensate for the occurrence of measurement fluctuations. The sheath of the rechargeable battery cell is then often of paper. The paper need not be removed as is the case in the prior art but instead can be used for securing the thermosensor element.

Exemplary embodiments of the invention are described in further detail below in conjunction with the schematic drawings. Shown are:

FIG. 1, securing an NTC resistor in the case of a rechargeable battery pack in the prior art;

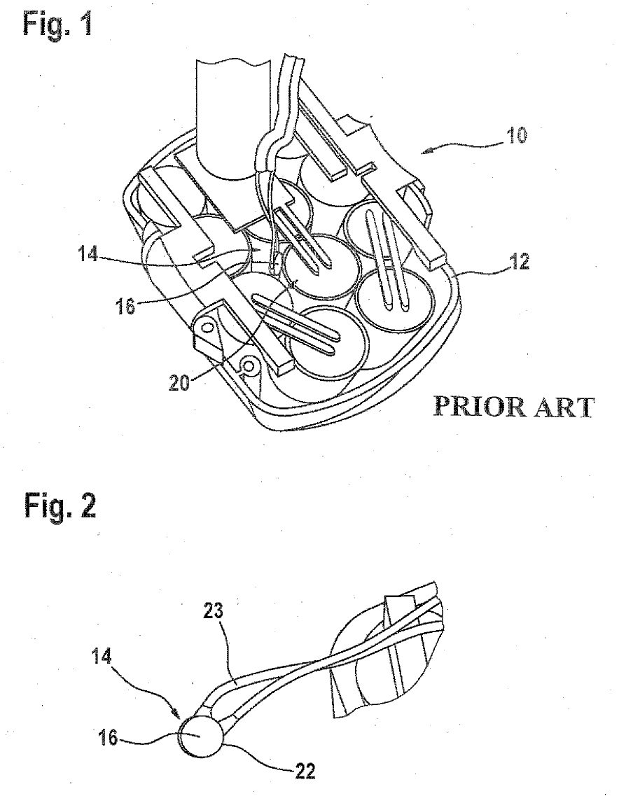

FIG. 2, a view of a commercially available wired NTC resistor;

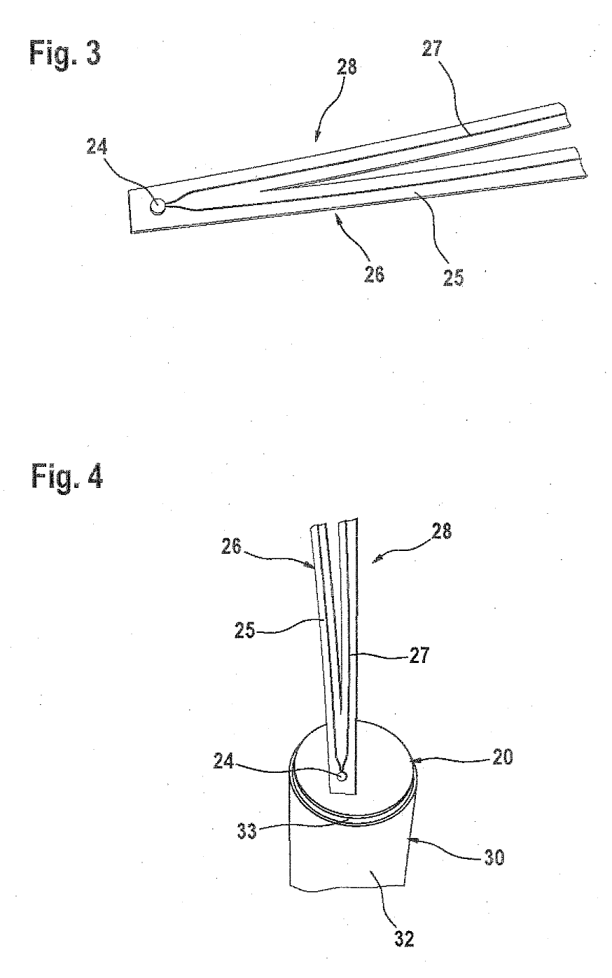

FIG. 3, a commercially available NTC resistor that is mounted without a housing on a ribbon cable;

FIG. 4, the assembly of a measurement arrangement of the invention in the case of a rechargeable battery pack; and

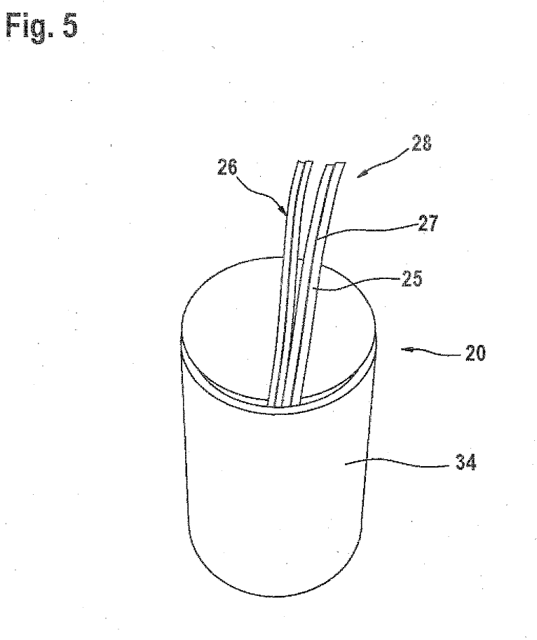

FIG. 5, a rechargeable battery cell of the invention in the mounted state.

FIG. 1, as a rechargeable power supply device 10, first shows a conventional rechargeable battery pack 12. In the prior art, a normal NTC resistor 16 is glued to a rechargeable battery cell 20 of the rechargeable battery pack 12 by means of an adhesive tape (not shown).

In FIG. 2, a commercially available wired NTC resistor 16 is shown, of the kind used in the prior art as a thermosensor element 14. The NTC resistor 16 has a housing 22 and sheathed wires 23.

In contrast to that, FIG. 3 shows an NTC resistor 24, which according to the invention is mounted without a housing on a ribbon cable 26 comprising wires 27 and a sheetlike substrate material 25, in order to form a thermosensor element 28. This has the advantage, as can clearly be seen from a comparison of FIGS. 2 and 3, that the mode of construction of the thermosensor element 28 in FIG. 3 is clearly shallower than that of the thermosensor element 14 in FIG. 2, since the housing is omitted, and the wires 27 are applied to a sheetlike substrate material 25.

The mounting of this thermosensor element 28 on a rechargeable battery cell 20 as an object 30 being measured is shown in FIG. 4. The flat conductor, with the NTC resistor 24 secured to it, is thrust between the rechargeable battery cell 20 and its sheath 32, or into the gap 33 between them. The sheath 32 of a rechargeable battery cell 20 for instance comprises paper, but any other material that is suitable for sheathing such a rechargeable battery cell 20 is also conceivable.

In FIG. 5, the complete rechargeable battery cell 20 of a measurement arrangement 34 according to the invention is shown, in which the thermosensor element 28 is mounted thereon. In principle, the invention is not limited to NTC resistors 24 for forming a thermosensor element 28. For instance, a PTC resistor can also be used, or some other thermosensor element of shallow construction that can for instance also be connected to a flat conductor. It is also conceivable not merely to secure one thermosensor element 28 to the rechargeable battery cell 20 but also to dispose at least two thermosensor elements 20 at various positions on the rechargeable battery cell 20, in order to compensate for measurement fluctuations or imprecisions.

1-7. (canceled)

8. A measurement arrangement for measuring a temperature of a rechargeable power supply device for an electrical appliance, in which the power supply device has at least one object being measured wherein at least one thermosensor element is provided on a ribbon cable and is disposed in a gap between the object being measured and an outer sheath.

9. The measurement arrangement as defined in claim 8, wherein at least two thermosensor elements are disposed at different positions on the object being measured.

10. The measurement arrangement as defined in claim 9 wherein the thermosensor elements are disposed at opposed points and/or at different levels on the object being measured.

11. The measurement arrangement as defined in claim 8, wherein the thermosensor element is either a NTC resistor or a PTC resistor.

12. The measurement arrangement as defined in claim 11, wherein the NTC resistor or the PTC resistor is provided without a housing on the ribbon cable.

13. The measurement arrangement as defined in claim 8, wherein the rechargeable power supply device is a rechargeable battery pack.

14. The measurement arrangement as defined in claim 8, wherein the sheath is made of paper.

15. The measurement arrangement as defined in claim 8, wherein the object being measured is a rechargeable battery cell or a battery element, and the thermosensor element is disposed between the rechargeable battery cell or battery element and an outer sheath.

16. The measurement arrangement as defined in claim 15, wherein at least two thermosensor elements are disposed at different positions on the object being measured.

17. The measurement arrangement as defined in claim 16 wherein the thermosensor elements are disposed at opposed points and/or at different levels on the object being measured.

18. The measurement arrangement as defined in claim 15, wherein the ribbon cable comprises wires and a sheet-like substrate material.

19. The measurement arrangement as defined in claim 15, wherein the thermosensor element is either a NTC resistor or a PTC resistor.

20. The measurement arrangement as defined in claim 19, wherein the NTC resistor or the PTC resistor is provided without a housing on the ribbon cable.

21. The measurement arrangement as defined in claim 20, wherein the ribbon cable comprises wires and a sheet-like substrate material.

22. The measurement arrangement as defined in claim 8, wherein the ribbon cable comprises wires and a sheet-like substrate material.
